(19) United States
(12) Patent Application Publication
(10) Pub. No.: US 2024/0250753 A1
(43) Pub. Date: Jul. 25, 2024

(54) Ship Hull Inspection using a Swarm of Unmanned Underwater Vehicles equipped with Wireless Laser Systems

(71) Applicant: Berkeley Marine Robotics Inc., Cerritos, CA (US)

(72) Inventors: Alexandre Immas, Oakland, CA (US); Sushil Tyagi, Pacific Palisades, CA (US)

(21) Appl. No.: 18/378,338

(22) Filed: Oct. 10, 2023

Related U.S. Application Data
(60) Provisional application No. 63/414,865, filed on Oct. 10, 2022.

(51) Int. Cl. H04B 10/112; B63C 11/52; B63G 8/00; H04B 13/02

(52) U.S. Cl. CPC H04B 10/112; B63C 11/52; B63G 8/001; H04B 13/02; B63G 2008/004

(57) ABSTRACT

A swarm of Unmanned Underwater Vehicles (UUVs) is used to inspect ships' hulls rapidly and comprehensively. The swarm forms an arc-shaped line that is operated from a guide vessel. Each UUV, except the one at the distal end of the arc, receives a modulated laser signal from the more distal UUV, amplifies the signal and sends it with its own data to a proximal UUV until the signal reaches a control station on the guide vessel. The optical communication enables remote control, live feedback as well as accurate localization data. High bandwidth communication provides high resolution video capable of training machine learning systems to identify biofouling, corrosion and contraband objects on the hull.

### CROSS-REFERENCE TO PRIOR APPLICATIONS

The current application is based on and claims priority and benefit of U.S. Provisional Patent Application Ser. No. 63/414,865, filed on 10 Oct. 2022.

### U.S. GOVERNMENT SUPPORT

N/A

### BACKGROUND OF THE INVENTION

### Area of the Art

The current invention is in the area of robotic submersible vehicles and specifically is addressed to using linked vehicles for inspecting ship hulls.

### Description of the Background Art

Inspection of ship hulls has long been an important safety issue. Hull inspection is essential to discover mechanical defects so that repairs can be made before mechanical failures occur. An equally important reason for inspection is to detect regions of fouling (growth of marine organisms) so that the hull can be cleaned as needed. Fouling is a serious problem because the increased drag caused by the attached organisms slows the vessel and results in an excess consumption of fuel. With the current crisis of excess atmospheric carbon dioxide, it is even more important than ever to minimize drag and improve fuel economy. Furthermore, transport of invasive species has become an increasingly serious problem for maintaining the biodiversity of coastal ecosystems. Therefore, not only the presence of biofouling but identification of the fouling organisms has become of paramount importance.

A third reason for hull inspection is for security reasons. Illicit materials such as illegal drugs or banned technology items can be attached to ship hulls to avoid detection. Thus, interdicted items may enter or leave the United States. In addition, intelligence devices for espionage purposes can enter U.S. harbors undetected. Even devices intended to disable a ship can be placed on a hull and avoid detection prior to activation.

Today, underwater inspection is almost exclusively done using human divers; this puts humans at risk, takes a significant amount of time and provides data difficult to interpret and to track over time. Existing robotic systems have so far not provided any significant advantages over inspection by human divers. Remotely operated vehicles (ROVs) are occasionally used to replace divers [4, 5] but the inspections by ROVs take the same amount of time and their operations are hindered by their tethers, which prevent them from reaching complex niche areas and cause serious complications when they get tangled with underwater structures or ships propellers. Autonomously underwater vehicles (AUVs) unlike ROVs are not tethered by cables, thereby avoiding one of the serious drawbacks of ROVs. However, AUVs have not been used outside research projects [6, 7] because of the inability to establish effective, data-rich communication between the vehicle and the operator. Radio communication is not effective in underwater situations and acoustic communications are not reliable in ports because of reflections and background noise [8]. Hence, AUVs are often not reliably controlled by their operators and present an unacceptable risk of collision with manned vessels.

Therefore, there is a significant need for a reliable communication system that would enable UUVs to inspect ship hulls and other underwater structures quickly, safely and reproducibly.

### SUMMARY OF THE INVENTION

A swarm of Unmanned Underwater Vehicles (UUVs) is used to inspect ships' hulls in a fast, comprehensive and repeatable manner. The swarm forms an arc-shaped line that is operated from a guide vessel (e.g., power boat, crew vessel) located at one of the arc's ends. Each UUV, except the one at the distal end of the arc, receives a signal from the distal UUV, amplifies the signal and sends it with its own data to a proximal UUV until the signal reaches a control station installed on the guide vessel [1, 2]. The vehicles send and receive data wireless using optical frequencies, enabling remote control, live feedback as well as accurate localization in GPS-denied environments such as underwater [3]. Wireless capabilities enable seamless reconfiguration of 2-12 UUVs according to ships geometry, which would be impossible with Remotely Operated Vehicles (ROVs) because of their tether cables, and guarantees no interference with manned vessels, which is not possible with Autonomous Underwater Vehicles (AUVs) because of the lack of communication during operation.

### DESCRIPTION OF THE FIGURES

FIG. 1 shows diagrams of a swarm of UUVs forming a line around or near a ship hull in optical communication with a surface vessel; in FIG. 1A the line is arc-shaped to inspect the entire hull; in FIG. 1B the line is more or less straight to inspect a bow thruster;

FIG. 2 shows a diagram of a prototype of the inventive UUV;

FIG. 3 is a block diagram of the Guidance, Navigation and Control systems of the UUV;

FIG. 4 shows a system ray diagram of the laser communication system of the UUV; and

### DETAILED DESCRIPTION OF THE INVENTION

The following description is provided to enable any person skilled in the art to make and use the invention and sets forth the best modes contemplated by the inventors of carrying out their invention. Various modifications, however, will remain readily apparent to those skilled in the art, since the general principles of the present invention have been defined herein specifically to provide a laser-based communication system that enables a swarm of UUVs to successfully inspect underwater structures such as ship hulls.

According to the present invention a swarm or fleet of UUVs is used to inspect ships' hulls in a fast, comprehensive and repeatable manner. The members of the fleet are coordinated to form an arc-shaped line. The fleet is operated from a guide vessel (e.g., a deck boat, a small crew vessel, etc.) located at one of the line's ends. The UUVs are man portable, fully actuated and exchange data wireless using optical frequencies. Each UUV is equipped with laser communication systems that have a laser-based modem and a Pointing, Acquisition and Tracking (PAT) system to meet the precision requirement for laser beam steering. Hence, a full-duplex optical communication is set up between the UUVs to form an optical daisy chain thereby enabling data transmission at speed greater or equal to 10 Mbps using an Ethernet protocol. Each UUV, except the one at the free extremity of the line, receives a signal from another UUV, amplifies the signal and sends it with its own data to the following UUV until the signal reaches a control station installed on the surface vessel.

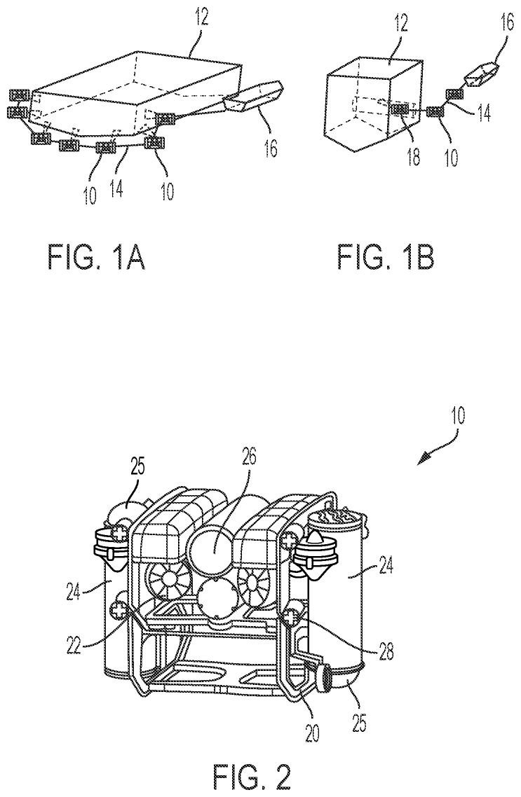

When a ship is at berth or at an anchorage (or even when moving at a slow speed), the line of UUVs is able to scan the ship's hull from bow to stern, moving forward at the same speed as the scanned vessel, as shown in FIG. 1A. The UUVs 10 operate autonomously in a coordinated manner to scan the ship hull 12, maintaining a distance between units that is less than the maximum optical range. The laser communication system provides accurate, (within the range of 1-10 cm) relative positioning between UUVs enabling localization of the data and, in conjunction with other sensors, close inspection of the hull without collision. The laser beams 14 link the UUVs. In addition, real-time feedback provides a second layer of safety because it allows the operator at a control station, often located in a guide vessel 16, to continuously check the UUVs' video feed and to take manual control if necessary. After completing the scan of the hull, the UUVs can also perform a detailed inspection of niche areas (e.g., propellers, sea chest, etc.). As shown in FIG. 1B. For this task, the distal UUV 18 is remotely controlled by the operator to reach the niche areas; the remaining UUVs, in a different autonomous mode, are used to relay the signal to and from the UUV 18 carrying out the inspection to the operator in the guide vessel 16. Immediately after inspection, the video feed acquired by the UUVs is post-processed by a computer vision algorithm to compute the percentage of hull with biofouling, to identify species involved in the biofouling, to detect any structural defects (e.g., corrosion) and to identify any hull-attached contraband items.

The prototype vehicles used to test the invention were a modified version of the BlueROV2 produced by BlueRobotics of Torrance, CA. As shown in FIG. 2, the UVV 10 consists of a frame 20 to which various components are mounted. The UUV 10 can be controlled in all six degrees of freedom thanks to multiple steerable propellers 20. It is equipped with an inventive, laser communication systems 24 to communicate with neighboring vehicles and has an on-board HD camera 26 with a wide-angle lens (80° horizontal field of view) installed on a tilt system and a side-scan sonar (here housed with the laser communication systems 24 and associated electronics) to acquire data on hull fouling. Bright LED lights 28 are also available to illuminate the hull (additional sonar transducers may be mounted with these LEDs).

The laser communications system 24 consists of a laser-based modem and a Pointing, Acquisition and Tracking (PAT) system in a watertight enclosure (here cylindrical). The laser beams exit and enter the system 24 through transparent domes 25. The optical communication range in turbid water provides the upper bound on the distance between UUVs normally limiting communication to 5-10 m depending on water turbidity [9]. The dimensions of cargo ships varies widely from a length, beam and draft respectively of 50 m, 10 m and 2 m up to 400 m, 60 m and 16 m for the largest cargo ships. However, most port calls are made with ships below 5,400 TEU (twenty-foot equivalent unit) in capacity, corresponding to Panamax ships which have a length, beam and draft respectively of 290 m, 32 m and 12 m. Therefore, a line of 2-12 UVVs, depending on water turbidity and ship size, is needed to scan the entire ship's hull.

On-board accelerometers, gyroscopes and magnetometer are used to measure the UUVs linear and angular acceleration, angular velocities and heading. In addition, a Doppler Velocity Log (DVL) is used to estimate velocity and distance with respect to the scanned surface of the ship's hull. The DVL has four angled transducers that send acoustic waves which are reflected by any opposing surface. It measures the frequency shift (Doppler Effect) between transmitted and received signal to estimate relative velocity and measured time of flight of the signal to estimate distance. The DVL is disposed towards the top of the UUV 10 to scan the hull bottom, or to the side of the UUV 10 to scan the hull's port or starboard sides. Finally, a multibeam sonar can also be mounted on the UUV, vertically (or horizontally) to scan the hull's bottom (or port and starboard sides with a horizontally mounted sonar), to avoid collision with the hull. It must be understood that although the UUV 10 in FIG. 2 is shown with the optical communication/sonar systems 24 on the right and left sides, the UUV 10 is completely reorientable when submerged, so that those systems 24 are then located on the top and bottom of the UUV. The sonar system sends multiple acoustic waves simultaneously in a fan-shaped pattern and estimates the hull geometry in the vicinity of the UUV by measuring time of flight between transmitted and received signals. It can also provide images of the hull which complement data from HD camera by detecting damages to the coating or hull-attached contraband items and by providing better resolution of the fouling and attached objects in dark murky waters.

Guidance, Navigation and Control systems. The guidance system runs at a low frequency (0.25-1 Hz) on an on-board companion computer (e.g., a Raspberry Pi); the navigation and control systems run at a higher frequency (400 Hz) in the BlueROV2's autopilot hardware (Pixhawk). The navigation and control systems use an Extended Kalman Filter (EKF) and an Adaptive Feedback Linearization Controller (AFLC) to ensure good performance in trajectory tracking, disturbance rejection and noise insensitivity [12, 13]. The state of the UUV is estimated using on-board measurements (e.g., IMU—inertial measurement unit, DVL, hydrostatic pressure sensor) and measurements of the UUV's position with respect to the surface vessel by means of the laser systems.

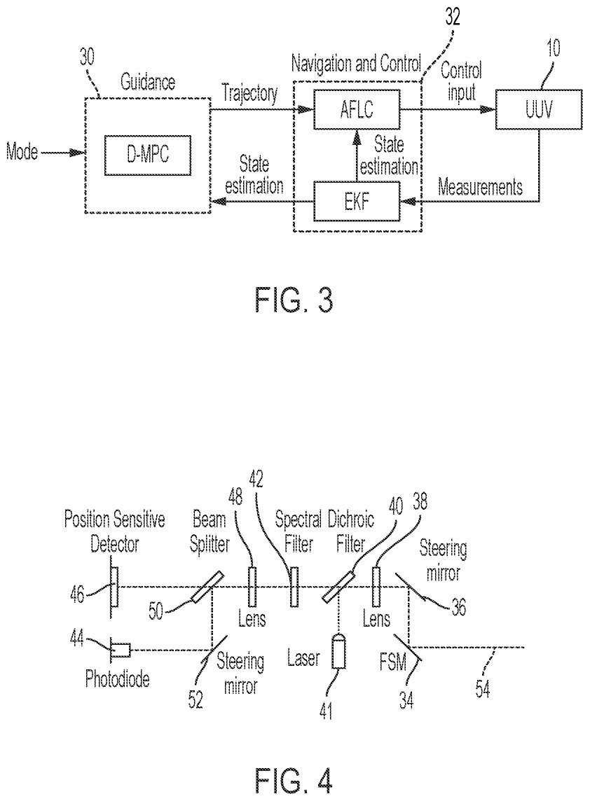

For guidance and control purposes the swarm formation is described as a graph G={V, E} where Vis the set of nodes that include the UUVs, and the surface vessel and E is the set of edges corresponding to optical communication links between successive nodes. The decentralized control scheme of the UUVs uses a hierarchical framework as shown diagrammatically in FIG. 3. The Guidance module 30 uses a Decentralized Model Predictive Control (D-MPC) [10, 11] to compute the vehicle's trajectory according to the swarm's mode of operation: hull scan or niche areas inspection. The trajectory is passed to a Navigation and Control module 32 where the AFLC computes the control input for the UUV. The UUV's sensors return measurements to the Navigation and Control module 32 where the EKF processes these measurements and provides feedback to the other subsystems.

Two formulations of the D-MPC and of the graph G are programmed into the UUVs as functions of the swarm's mode. In the first mode, the UUVs are autonomous and the D-MPC's objective is to keep the UUV in the same vertical plane perpendicular to the long ais of the vessel being inspected and at a constant distance from the hull under the constraints that: (i) any two successive UUVs remain within optical communication range; and (ii) collisions with the hull are avoided. The hull geometry measured by the multibeam sonar is used to formulate the distance objective and the collision avoidance constraints; predictions of the surface vessel and neighboring UUVs positions are used to formulate the vertical plane objective and communication constraints. In the second mode, one UUV becomes a leader and is remotely controlled by the operator in the guide vessel 16 to reach a niche areas. The other UUVs, which act as autonomous agents, are used to relay the signals to and from the remotely controlled UUV and the guide vessel 16, according to graph G. The D-MPC of the relay vehicles is formulated such that two successive UUVs remain within optical communication range at the same time automatically avoiding collision with the hull and other UUVs.

Laser communication system. A full-duplex laser communication using Ethernet protocol is established between successive UUVs. Blue-green laser diodes of class IIIB (50-60 mW) are modulated to send data at, for example, 10 Mbps. On the receiving side, a transimpedance amplifier converts the current of a photodiode to a voltage signal that is then converted back to an Ethernet signal using a comparator [14]. Once alignment is realized, the modems detect the data rate, immediately establish connection and handles any packet errors.

The laser communication system combines a laser modem with a PAT system, as shown in FIG. 4. The receiver and transmitter share a common optical path 54 that goes through a Fast-Steering Mirror (FSM) 34 [15, 16], a first steering mirror 36 and a first lens 38. The FSM has a bandwidth of 20 Hz over a large field of view of 100 degrees and is thus able to track large displacements of the UUVs. It also has high precision (≈1 millidegree) and high bandwidth (>200 Hz) for small angle variations of ±1 degree enabling it to maintain communication despite any small movements of the UUVs. Receiving and transmitting laser beams have different wavelengths (e.g., 520 nm and 488 nm), which are separated by a dichroic filter 40. In addition, a spectral filter 42 and, optionally, a field of view filter (not shown) are used to ensure that the photodiode 44 (for data reception) and the Position-Sensitive Detector (PSD, e.g., a CMOS image sensor) 46 receive only the modulated laser light from the leading or following UUVs. A second lens 48 is used to realize the image of the incoming laser beam on the two detectors' 44, 46 plane while a beam splitter 50 divides the received light between them. A second steering mirror 52 optimizes the signal at the photodiode 44. It will be appreciated that each UUV 10 has two complete laser communication systems 24: one to transmit to and receive from the next UUV in the line, and one to transmit to and receive from the previous UUV in the line. One of the two systems uses a 520 nm laser and the other uses a 488 nm laser; the dichroic filters are, in each case, selected to keep the transmitting laser's output from reaching the receiving photodiode 44. Note that in FIG. 2 the some-shaped end on each communication system 24 represents the aperture through which laser beams enter and exit the system 24. When submerged the UUV 10 is usually oriented with the communication systems 24 on the “top” and “bottom” of the UUV 10 pointing towards the UUVs on the left and right in the line.

During acquisition, the FSM's orientation follows a spiral pattern allowing the transmitter to find the receiver of its neighboring UUV. Once light is detected on one of the UUV's receiver, the latter estimates the orientation of the incoming light and directly points its laser in that same direction. The fine steering system then switches to tracking where a feedback control loop keeps the lasers aligned using the incoming laser's beam position as measured by the PSD 46. If the optical communication link between two UUVs is lost, the PAT system immediately switches back to acquisition to re-align the modems in the same manner as during initialization. The position of the UUVs are obtained in the surface vessel's frame of reference by computing the time of flight of the laser beam between two successive UUVs combined with the orientation of the FSM system [16, 17].

Image Processing. Overall, the inventive image processing system requires four technical elements:

A). Autonomous: Without requiring an operator, the UUV swarm can move along a structure at constant distance and constant speed recording the video and sensor data which represent hull conditions. Although the units swarm units could be called “autonomous underwater vehicles” (AUV), this term usually implies devices operating completely independently and not in communication so that recorded data must be retrieved later (i.e., when the AUV returns “home”). Although the devices of the current invention do have such autonomous capability, they are used “human in loop” with constant real-time communication with guide boat that launched them. Because there is no GPS or Wi-Fi underwater and because acoustical communication systems are too low in bandwidth for transmitting video type data, so that reliable underwater wireless communication in real-time and at high bandwidth are not readily available. Although real-time feedback/control autonomy is readily achieved on land, air, and on surface (i.e., floating), it's not yet not readily feasible underwater.

B) Swarm: Although a single unit could be autonomous even without real-time communication, it is not possible for multiple units to coordinate underwater and hold their shape of swarm unless they have effective control and communication amongst and between units. Although tethers (i.e., hard wired) can pass data, they get weighed down and entangled with each other—particularly, when there are multiple swarm units in proximity. Undeterred swarm control/communication wirelessly is only possible by means of the laser systems disclosed herein.

C). Underwater wireless laser communication: This is the enabler of prior two capabilities (autonomy and swarm). Laser underwater communication is still not readily available and when it is, it usually operates only between two (relatively closely spaced) points. The daisy chained laser communication of the current invention enables (and requires) swarm behavior.

D). Machine vision: The first three capabilities enable the real time delivery of underwater data such as video of seafloor or submerged structures such as ship hulls which is then processed via an Artificial Intelligence/Machine Learning (AI/ML) algorithms to detect patterns and anomalies and to generate, thereby, predictions of future underwater state. AI machine learning models themselves are not novel, but they become unique when trained on unique large scale data sets. Such underwater data is currently not readily available. Because machine learning models require standardized data (always recorded the same way) and at a large scale, data sets recorded by the inventive swarm are particularly valuable.

Using an autonomous swarm of UUVs provides a means to generate large number of standard data sets—and their autonomous capture in same identical format makes the underlying ML model more reliable and better trained than the ones using random diver recorded videos.

Once ingested these underwater data needs to go through multiple processes—(1) enhance the images, (2) train the model with known data and then apply to a new data, (3) identify the features or anomalies which are being sought in underwater data, (4) and then use generative AI to predict patterns that are likely to be seen in future on the target structure (e.g., increased biofouling, increased corrosion, contraband items, etc.).

These trained algorithms can detect patterns/objects in “degraded environment” underwater where visuals are generally blurry and rarely sharp or ideal. Still with large scale data in standard form produced by the autonomous swarm, one can train the ML model to detect objects and anomalies even when the image is blurry and degraded visually.

The following claims are thus to be understood to include what is specifically illustrated and described above and what can be obviously substituted. Those skilled in the art will appreciate that various adaptations and modifications of the just-described preferred embodiment can be configured without departing from the scope of the invention. The illustrated embodiment has been set forth only for the purposes of example and that should not be taken as limiting the invention. Therefore, it is to be understood that, within the scope of the appended claims, the invention may be practiced other than as specifically described herein.

### CITED REFERENCES

[1] A Immas, M Saadat, J Navarro, M Drake, J Shen, and M-R Alam. High-bandwidth underwater wireless communication using a swarm of autonomous underwater vehicles. In ASME 2019 38th International Conference on Ocean, Offshore and Arctic Engineering. American Society of Mechanical Engineers Digital Collection, 2019.
[2] M-R Alam, A Immas, and M Saadat. Underwater free space optical communication systems.
WO2019204319A1. Patent pending.
[3] John R Potter, Michael B Porter, and James C Preisig. Ucomms: A conference and workshop on underwater communications, channel modeling, and validation. IEEE Journal of Oceanic Engineering, 38(4):603-613, 2013.
[4] A Antony JACOB, Manas GALIPALLI, Vineet UPADHYAY, Prabhu RAJAGOPAL, and Krishnan BALASUBRAMANIAM. Underwater inspection in lieu of dry-docking (uwild) using remotely operated vehicles (rov).
[5] Scott Reed, Jon Wood, Jose Vazquez, Pierre-Yves Mignotte, and Benjamin Privat. A smart rov solution for ship hull and harbor inspection. In Sensors, and Command, Control, Communications, and Intelligence (C3I) Technologies for Homeland Security and Homeland Defense IX, volume 7666, page 76662G. International Society for Optics and Photonics, 2010.
[6] Paul Ozog, Nicholas Carlevaris-Bianco, Ayoung Kim, and Ryan M Eustice. Long-term mapping techniques for ship hull inspection and surveillance using an autonomous underwater vehicle. Journal of Field Robotics, 33(3):265-289, 2016.
[7] Seonghun Hong, Dongha Chung, Jinwhan Kim, Youngji Kim, Ayoung Kim, and Hyeon Kyu Yoon. In-water visual ship hull inspection using a hover-capable underwater vehicle with stereo vision. Journal of Field Robotics, 36(3):531-546, 2019.
[8] Bas Binnerts, Koen Blom, and Stefania Giodini. Analysis of underwater acoustic propagation in a harbour environment and its effect on communication. IEEE, 2017.
[9] Brandon M Cochenour, Linda J Mullen, and Alan E Laux. Characterization of the beam-spread function for underwater wireless optical communications links. IEEE Journal of Oceanic Engineering, 33(4):513-521, 2008.
[10] A Immas and M-R Alam. Guidance, navigation and control of auvs for permanent underwater optical networks. IEEE Journal of Oceanic Engineering, in review.
[11] Tamas Keviczky, Francesco Borrelli, and Gary J Balas. Decentralized receding horizon control for large scale dynamically decoupled systems. Automatica, 42(12):2105-2115, 2006.
[12] Paul A Miller, Jay A Farrell, Yuanyuan Zhao, and Vladimir Djapic. Autonomous underwater vehicle navigation. IEEE Journal of Oceanic Engineering, 35(3):663-678, 2010.
[13] Thor I Fossen. Marine control systems-guidance. navigation, and control of ships, rigs and underwater vehicles. Marine Cybernetics, Trondheim, Norway, Org. Number NO 985 195 005 MVA, www.marinecybernetics. com, ISBN: 82 92356 00 2, 2002.
[14] Behzad Razavi. Design of integrated circuits for optical communications. John Wiley & Sons, 2012.
[15] Andrew S Fletcher, Scott A Hamilton, and John D Moores. Undersea laser communication with narrow beams. IEEE Communications Magazine, 53(11):49-55, 2015.
[16] Nicholas D Hardy, Hemonth G Rao, Stephen D Conrad, Thomas R Howe, Marvin S Scheinbart, Richard D Kaminsky, and Scott A Hamilton. Demonstration of vehicle-to-vehicle optical pointing, acquisition, and tracking for undersea laser communications. In Free-Space Laser Communications XXXI, volume 10910, page 109100Z. International Society for Optics and Photonics, 2019.
[17] V Milanovi'c, N Siu, A Kasturi, M Radoji\check{ }ci'c, and Y Su. Memseye for optical 3d position and orientation measurement. In MOEMS and Miniaturized Systems X, volume 7930, page 79300U. International Society for Optics and Photonics, 2011.

What is claimed is:

1. A system for underwater inspections comprising a line of unmanned and untethered underwater vehicles in optical communication with each other.

2. The system of claim 1, wherein data from one of said vehicles are relayed along the line by a laser-based optical communication system.

3. The system of claim 1, wherein data from each of said vehicles are relayed along the line by a laser-based optical communication system.

4. The system of claim 3, wherein the data are relayed along the line to a control station disposed at one end of the line.

5. The system of claim 2, wherein data are high resolution video data.

6. The system of claim 1, wherein data from one of said vehicles disposed at one end of said line are relayed along the line to a control station disposed at an opposite end of the line and wherein data from the control station are relayed to said one vehicle disposed at the opposite end of the line.

7. The system of claim 6, wherein the data from one of said vehicles disposed at one end of said line are high resolution video data and the data from the control station are remote control data.

8. The system of claim 1, wherein each of said vehicles autonomously maintains a positional relative to a surface to be inspected and relative to the nearest said vehicles in the line to maintain optical communication.

9. The system of claim 1, wherein said line comprises at least four of said vehicles.

10. The system of claim 1, wherein said line comprises at least eight of said vehicles.

11. The system of claim 8, wherein the surface is a hull of a ship.

12. The system of claim 11, wherein the hull is inspected for biofouling, corrosion, structural defects and contraband objects.

13. A method for underwater inspections comprising the steps of:
providing a plurality of unmanned, untethered underwater vehicles each equipped with video and optical communication capabilities;
allowing said plurality to establish a communication network allowing data transmission to and from unmanned underwater vehicle to unmanned underwater vehicle and to a control station;
establishing a line of said unmanned underwater vehicles wherein the control station is disposed at one end of the line; and
using the line to relay video data to the control station.

14. The method of claim 13 further comprising the step of sweeping the line along a hull of a ship.

15. The method of claim 14, wherein the hull is inspected for biofouling, corrosion, structural defects and contraband objects.

16. The method of claim 13, wherein the step of using relays video data only from said unmanned underwater vehicle disposed at an end of the line opposite the control station.

17. The method of claim 13, further comprising the step of processing the video data with a machine learning algorithm.
